(19) United States
(12) Patent Application Publication
(10) Pub. No.: US 2012/0327867 A1
(43) Pub. Date: Dec. 27, 2012

(54) Subframe Scheduling

(75) Inventors: Kalle Petteri Kela, Kaarina (FI); Pasi Petteri Yliuntinen, Turku (FI)

(73) Assignee: Renesas Mobile Corporation, Tokyo (JP)

(21) Appl. No.: 13/169,338

(22) Filed: Jun. 27, 2011

(51) Int. Cl. H04W 72/12

(52) U.S. Cl. 370/329

(57) ABSTRACT

Scheduling of subframes is disclosed. In a method, a reverse scheduling received by a terminal from a base station is obtained. The reverse scheduling includes information indicating that at least a part of subframes is not utilized for a radio data transmission between the terminal and the base station. The radio data transmission between the terminal and the base station is caused to operate according to the reverse scheduling.

### FIELD

The invention relates to wireless communications, and, particularly, to subframe scheduling.

### BACKGROUND

In a radio system, a base station assigns radio resources to a terminal and signals this information to the terminal using a control channel. In 3GPP Long Term Evolution (LTE), transmissions are performed in one millisecond time periods called subframes. A downlink (DL) assignment or an uplink (UL) grant is transmitted when resources in a subframe are assigned for the terminal. Semi-persistent scheduling enables radio resources to be semi-statically configured and allocated to a terminal for a longer time period, avoiding the need for specific downlink assignment or uplink grant to be sent in every subframe.

### BRIEF DESCRIPTION

According to an aspect of the present invention, there is provided an apparatus comprising: at least one processor; and at least one memory including computer program code; the at least one memory and the computer program code are configured to, with the at least one processor, cause the apparatus to perform at least the following: obtain a reverse scheduling received by a terminal from a base station, the reverse scheduling comprising information indicating that at least a part of subframes is not utilized for a radio data transmission between the terminal and the base station; and cause a radio transceiver of the terminal to operate according to the reverse scheduling in the radio data transmission between the terminal and the base station.

According to another aspect of the present invention, there is provided another apparatus comprising: at least one processor; and at least one memory including computer program code; the at least one memory and the computer program code are configured to, with the at least one processor, cause the apparatus to perform at least the following: create a reverse scheduling for a terminal, the reverse scheduling comprising information indicating that at least a part of subframes is not utilized for a radio data transmission between the terminal and a base station; cause a transmission of the reverse scheduling from the base station to the terminal; and cause a radio transceiver of the base station to operate according to the reverse scheduling in the radio data transmission between the terminal and the base station.

### LIST OF DRAWINGS

Example embodiments of the present invention are described below, by way of example only, with reference to the accompanying drawings, in which

FIGS. 1A and 1B illustrate example embodiments of apparatuses;

FIGS. 2 and 5 illustrate example embodiments of a radio system;

FIG. 3 illustrates an example embodiment of a terminal;

FIG. 4 illustrates an example embodiment of a base station;

FIGS. 6 and 7 illustrate example embodiments of scheduling;

FIGS. 8 and 9 illustrate example embodiments of signaling related to scheduling; and

FIGS. 10A, 10B, 11A, and 11B illustrate example embodiments of methods.

### DESCRIPTION OF EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

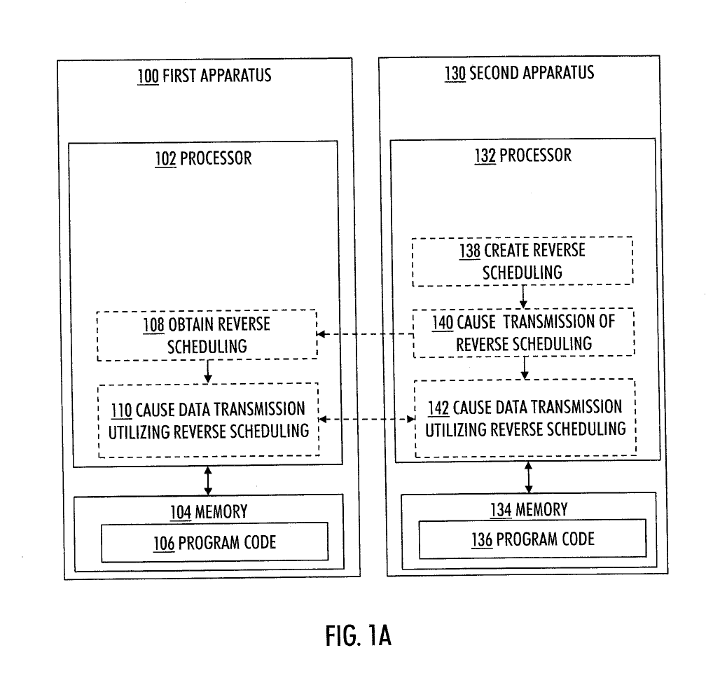

FIGS. 1A, 1B, 3 and 4 illustrate example embodiments of apparatuses 100, 130. FIGS. 1A, 1B, 3 and 4 only show some elements whose implementation may differ from what is shown. The connections shown in FIGS. 1A, 1B, 3 and 4 are logical connections; the actual physical connections may be different. Interfaces between the various elements may be implemented with suitable interface technologies, such as a message interface, a method interface, a sub-routine call interface, a block interface, a hardware interface, a software interface or any means enabling communication between functional sub-units. It should be appreciated that the apparatuses 100, 130 may comprise other parts. However, such other parts may be irrelevant to the described example embodiments and, therefore, they need not be discussed in more detail here. It is also to be noted that although some elements are depicted as separate ones, some of them may be integrated into a single physical element.

As shown in FIG. 1A, the first apparatus 100 comprises at least one processor 102, and at least one memory 104 including computer program code 106. The at least one memory 104 and the computer program code 106 are configured to, with the at least one processor 102, cause the first apparatus 100 to perform the following: obtain 108 a reverse scheduling received by a terminal from a base station. The reverse scheduling comprises information indicating that at least a part of subframes is not utilized for a radio data transmission between the terminal and the base station. Furthermore, the at least one memory 104 and the computer program code 106 are configured to, with the at least one processor 102, cause the first apparatus 100 to perform the following: cause 110 a radio transceiver of the terminal to operate according to the reverse scheduling in the radio data transmission between the terminal and the base station.

In another embodiment, shown in FIG. 1B, the at least one memory 104 and the computer program code 106 are configured to, with the at least one processor 102, cause the first apparatus 100 to perform the following: obtain 112 a semi-persistent scheduling received by a terminal from a base station. The semi-persistent scheduling comprises information on scheduling of the subframes utilized in the radio data transmission between the terminal and the base station. The at least one memory 104 and the computer program code 106 may be configured to, with the at least one processor 102, cause the first apparatus 100 to perform the following: cause 114 a radio transceiver of the terminal to operate according to the semi-persistent scheduling in the radio data transmission between the terminal and the base station.

Additionally, the at least one memory 104 and the computer program code 106 are configured to, with the at least one processor 102, cause the first apparatus 100 to perform also the following: obtain 108 a reverse scheduling received by the terminal from the base station.

Furthermore, the at least one memory 104 and the computer program code 106 are configured to, with the at least one processor 102, cause the first apparatus 100 to perform also the following: cause 116 changes to the semi-persistent scheduling on the basis of the reverse scheduling, thereby arriving at a reversed semi-persistent scheduling.

Finally, the at least one memory 104 and the computer program code 106 are configured to, with the at least one processor 102, cause the first apparatus 100 to perform also the following: cause 110 a radio transceiver of the terminal to operate according to the reversed semi-persistent scheduling in the radio data transmission between the terminal and the base station.

The first apparatus 100 may be a terminal, e.g. user equipment (UE), a radio terminal, a subscriber terminal, smartphone, mobile station, mobile phone, portable computer, pad computer or some other type of wireless mobile communication device operating with or without a subscriber identification module (SIM). The terminal may be a piece of equipment or a device that is configured to associate the terminal and its user with a subscription and allows a user to interact with the radio system, e.g. the terminal is capable of requesting service from the radio system. The terminal presents information to the user and allows the user to input information. In other words, the terminal may be any terminal capable of wirelessly receiving information from and/or wirelessly transmitting information to the radio system. Besides communication capabilities, the terminal may include computer functionalities or functionalities of other data processing devices.

However, the first apparatus 100 may also be interpreted as a circuitry implementing the required functionality within the terminal. As was explained, the first apparatus 100 obtains 108 the reverse scheduling, and causes 110 the data transmission according to the reverse scheduling.

If the first apparatus 100 is the terminal, then it will also comprise the equipment needed for the communication, such equipment including at least one radio transceiver with all the required hardware and software. On the other hand, if the first apparatus 100 is the circuitry, then it will not necessarily comprise the radio transceiver(s) etc. but only interfaces enabling communication with such equipment implementing the communication with the base station, for example. The first apparatus 100 may be a wireless modem designed to be used in a terminal, or in any other product, such as cars, sensor networks, multimedia, or another product requiring wireless communication capabilities. The wireless modem may be designed for a terminal, or it may be a separate product, such as a USB (Universal Serial Bus) stick capable of being plugged into a product, such as a portable computer, or any other product requiring wireless communication capabilities.

As shown in FIG. 1A, the second apparatus 130 comprises at least one processor 132, and at least one memory 134 including computer program code 136. The at least one memory 134 and the computer program code 136 are configured to, with the at least one processor 132, cause the second apparatus 130 to perform the following: create 138 a reverse scheduling for a terminal, cause 140 a transmission of the reverse scheduling from the base station to the terminal, and cause 142 a radio transceiver of the base station to operate according to the reverse scheduling in the radio data transmission between the terminal and the base station.

In another embodiment, shown in FIG. 1B, the at least one memory 134 and the computer program code 136 are configured to, with the at least one processor 132, cause the second apparatus 130 to perform the following: create 144 a semi-persistent scheduling for a terminal communicating with a base station. The semi-persistent scheduling comprises information on scheduling of the subframes utilized in the radio data transmission between the terminal and the base station.

Additionally, the at least one memory 134 and the computer program code 136 are configured to, with the at least one processor 132, cause the second apparatus 130 to perform also the following: cause 146 a transmission of the semi-persistent scheduling from the base station to the terminal.

The at least one memory 134 and the computer program code 136 may be configured to, with the at least one processor 132, cause the second apparatus 130 to perform the following: cause 148 a radio transceiver of the base station to operate according to the semi-persistent scheduling in the radio data transmission between the terminal and the base station.

Additionally, the at least one memory 134 and the computer program code 136 are configured to, with the at least one processor 132, cause the second apparatus 130 to perform also the following: create 138 a reverse scheduling for the terminal, and cause 140 a transmission of the reverse scheduling from the base station to the terminal.

Additionally, the at least one memory 134 and the computer program code 136 are configured to, with the at least one processor 132, cause the second apparatus 130 to perform also the following: cause 150 changes to the semi-persistent scheduling on the basis of the reverse scheduling, thereby arriving at a reversed semi-persistent scheduling, and cause 142 a radio transceiver of the base station to operate according to the reversed semi-persistent scheduling in the radio data transmission between the terminal and the base station.

The second apparatus 130 may be a base station, e.g. a Node B, enhanced or evolved NodeB (eNB), a home eNode B (HeNB), an access point (AP), an IEEE 802.11 based access point, a femto node, a femto base station, or any other equipment belonging to the network infrastructure of the radio system, and implementing the radio communication interface with the terminal.

However, the second apparatus 130 may also be interpreted as a circuitry implementing the required functionality within the base station. As was explained, the second apparatus 130 creates 138 the reverse scheduling, causes 140 transmission of the reverse scheduling, and causes 142 data transmission with the reverse scheduling.

If the second apparatus 130 is the base station, then it will also comprise the equipment needed for the communication such equipment including at least one radio transceiver with all the required hardware and software. On the other hand, if the second apparatus 130 is the circuitry, then it will not necessarily comprise the radio transceiver(s) etc. but only interfaces enabling communication with such equipment implementing the communication with the terminal, for example. The second apparatus 130 may be a wireless modem designed to be used in a base station, or another product requiring wireless communication capabilities.

The radio system may be any standard/non-standard/proprietary system that supports described kind of scheduling. In the present, such a system is evolved universal terrestrial radio access (E-UTRA), also known as long term evolution (LTE) for example, or their recent LTE-Advanced versions (LTE-A). However, the example embodiments are not restricted thereto, but may be applicable to other suitable radio systems (in their present forms and/or in their evolution forms), such as universal mobile telecommunications system (UMTS) radio access network (UTRAN or EUTRAN), a system based on International Mobile Telecommunication (IMT) standard or any one of its evolution versions (e.g. IMT-Advanced), wireless local area network (WLAN) based on IEEE (Institute of Electrical and Electronics Engineers) 802.11 standard or its evolution versions (IEEE 802.11ac), worldwide interoperability for microwave access (WiMAX), Wi-Fi, 3GPP, Bluetooth®, personal communications services (PCS) and systems using ultra-wideband (UWB) technology. In at least some of the embodiments, the radio access technology uses network controlled resource scheduling.

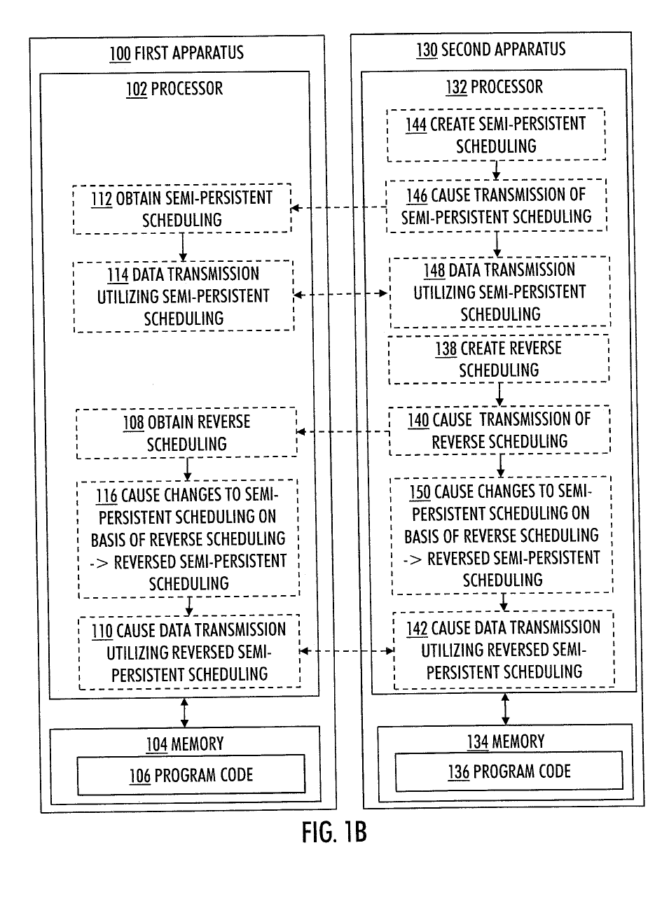

FIG. 2 illustrates an example of the radio system 202, Release 8 LTE. The three basic elements of the radio system 202 are UE 200 (=terminal), eNB (=base station) 204 in a radio network and an access gateway (a-GW) 210 in a core network. Functionalities of the eNB 204 may include: all radio protocols, mobility management, all retransmissions, header compression, and packet data convergence protocols. The a-GW 210 provides the interface of the cellular radio system 202 to/from the other networks 216 such as the Internet. The a-GW 210 may be streamlined by separating the user and the control planes: a mobility management entity (MME) 212 is just a control plane entity and the user plane bypasses MME 212 directly to a serving gateway (S-GW) 214.

Furthermore, the radio system 202 may comprise a Home eNodeB (HeNB) 206 (=base station) that may also interface with the a-GW 210. The HeNB 206 provides LTE radio coverage for the UE 200 by incorporating the capabilities of the eNB 204. As the flat architecture of the LTE 202 is not optimized for a very large number of HeNBs 206, a HeNB gateway 208 may be used to hide the large number of the HeNBs 206 from the a-GW 210.

In a cellular radio system, such as the one illustrated in FIG. 2, the reverse scheduling may be operated within one cell, within one base station, or within a group of base stations, depending on the situation. In such an environment, with the chance to affect the radio links of numerous terminals, the potential for achieving good results may be quite good.

Additionally, the base station may be a wireless access point of a local area network. Some example embodiments cover use in a macro cell cellular network, a cellular network having hierarchies of different cell sizes (macro, micro, pico, femto), heterogeneous networks, enterprise LAN, public hotspot networks, home networks, small enterprises, home offices, and public houses.

FIG. 2 only shows some network elements, but it should be understood that the radio system may also include other types of network elements. The number of network elements also varies depending both on the geographic coverage and on the number of users, for example.

Throughout this application, the terms base station and terminal are used consistently. It should be noted, however, that in some cases these network elements might also be known with other names. The basic difference between these two network elements is that the base station belongs to the network infrastructure, whereas the terminal belongs to the user of the system. As the general structure of the radio system, as well as the structures and functions of the network elements are well known in the art, their general structure will not be further described here, but the reader is advised to consult numerous textbooks and standards of the wireless telecommunications, such as 3GPP TS 36.XXX series.

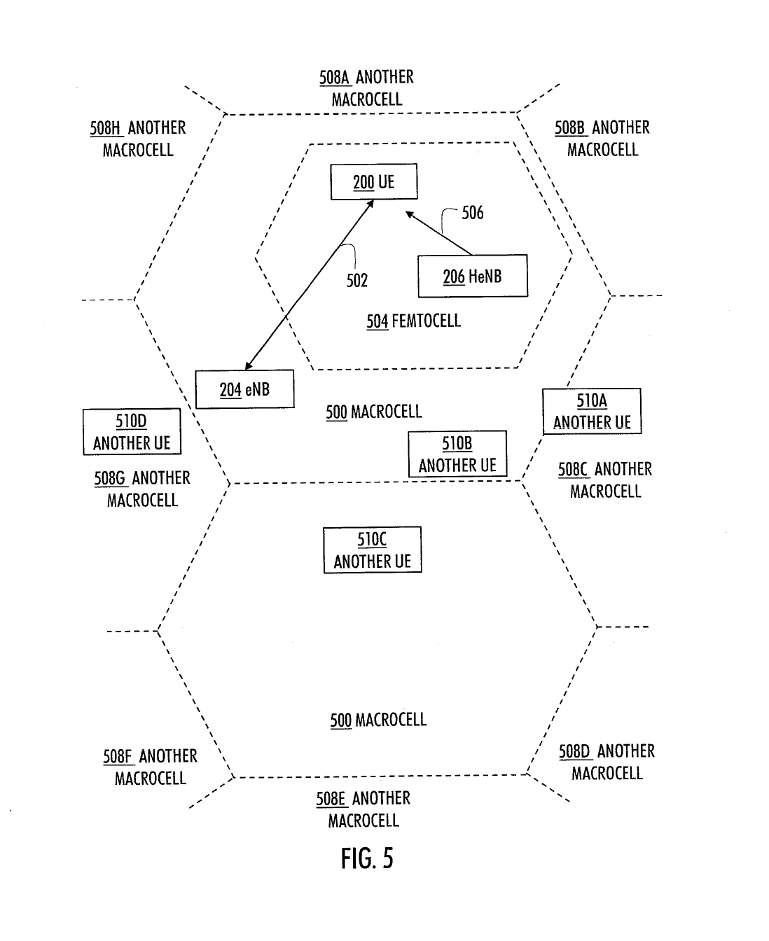

In FIG. 6, periodicity aspect of allocations is illustrated. The terminal may have several simultaneous semi-persistent reverse scheduling allocations with different periodicity. In the example embodiment of FIG. 6, there are two reverse scheduling allocations: the first allocation 600A, 600B with the first periodicity 604, and the second allocation 602A, 602B, 602C, 602D with the second periodicity 606. Note that also single subframe (non-persistent) reverse scheduling allocations are feasible.

Accordingly, the reverse scheduling may further comprise information indicating that the at least part of the subframes is not used in at least one of the following subframes utilized in the radio data transmission between the terminal 300, 200 and the base station 400, 204/206. Additionally, or alternatively, the reverse scheduling may further comprise information indicating that the at least part of the subframes is not used until further notice in the radio data transmission between the terminal 300, 200 and the base station 400, 204/206.

The reverse scheduling may further comprise information indicating that at least a part of downlink shared channels and/or a part of downlink control channels is not utilized for the radio data transmission from the base station 400, 204/206 to the terminal 300, 200. Additionally, or alternatively, the reverse scheduling may further comprise information indicating that at least a part of uplink shared channels and/or a part of uplink control channels is not utilized for the radio data transmission from the terminal 300, 200 to the base station 400, 204/206.

As the reverse scheduling indicates that at least a part of subframes is not utilized for radio data transmission, such subframes may be denoted as blank or almost blank subframes. As explained with reference to FIG. 1B, semi-persistent scheduling may be affected by the reverse scheduling. However, it is also possible to use reverse allocations without semi-persistent scheduling as well, e.g. the embodiments may also cover single subframe reverse allocations. Besides being used for shared channels, also other kinds of channels may be subjected to the reverse scheduling. Blank or almost blank subframes may be created in time domain where all (or a selected set of physical) channels are muted. E.g. control, synchronization, random access and broadcast channels may need to be muted in LTE.

Besides using reverse scheduling for cancellation of already allocated resources, it may be indicated that a subframe is almost blank subframe although no actual resources have been allocated to a certain terminal. Note that the terminal may otherwise transmit e.g. control data, HARQ (hybrid automatic repeat request) retransmissions or random access preambles. Similarly, the base station may normally transmit synchronization channels etc. in downlink unless muted. If downlink channels are muted, it may be beneficial for the terminal to know when downlink channels are not present.

The reverse scheduling may be in at least one of the following formats: downlink control information, and/or resource indication value. However, the list of the formats in non-exhaustive and other suitable formats may also be utilized, depending on the radio system and its various requirements.

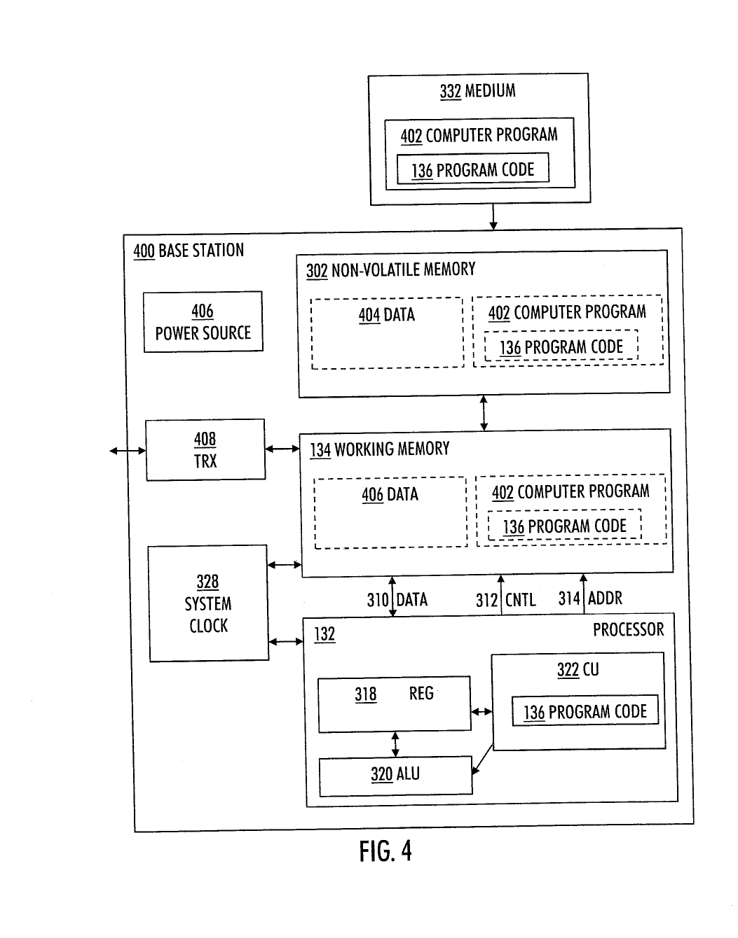

As illustrated in FIG. 5, in cellular networks, a terminal 200 is in varying radio conditions and its radio connection 502 to the base station 204 in a macrocell 500 may suffer from interference caused by a femtocell 504 transmission 506 from a HeNB 206, for example. Uplink transmissions of other terminals 510A, 510B, 510C, 510D and downlink transmissions of other macrocells 508A, 508B, 508C, 508D, 508E, 508F, 508G, 508H may also cause interference. There may be significant interference within the cell 500 and between different cells utilizing the same radio channel. Users with good radio link to the base station 204 are in better position compared to cell 500 edge users that have poor radio conditions due to e.g. path loss and bigger inter-cell interference. Such an embodiment is also possible, wherein the femtocell 504 is interfered by macro cells, and, instead of applying reverse scheduling for the femtocell, reverse scheduling is applied for the macrocell(s) in order to improve the interference situation in the femtocell.

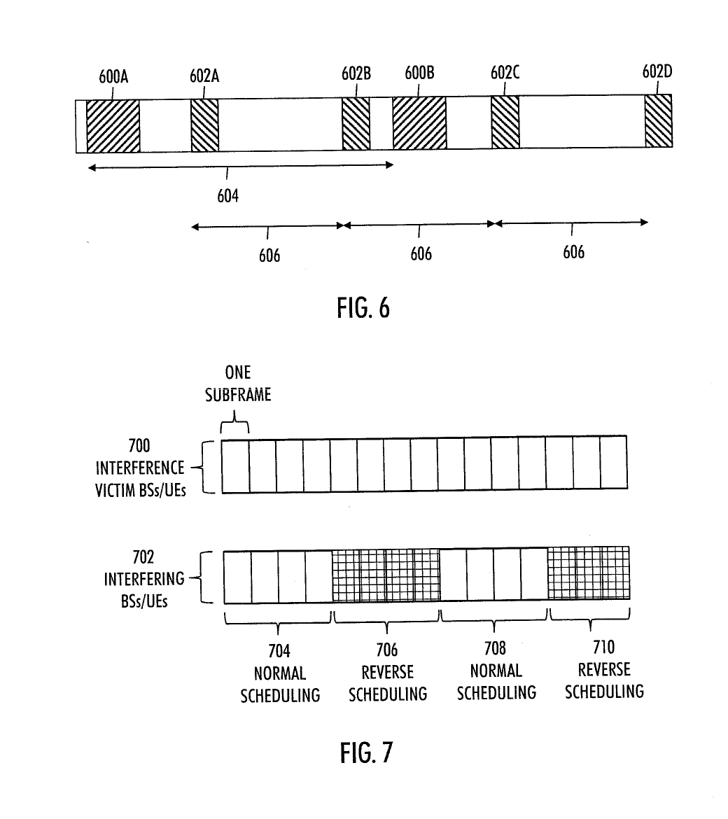

FIG. 7 illustrates that those base stations and/or terminals 700 that are victims of the interference may be helped with the reverse scheduling. This is achieved by muting some subframes 706, 710 with the reverse scheduling (as illustrated) of the interfering base stations and/or terminals 702, while leaving the remaining subframes 704, 708 unmuted.

A terminal 300, 200 may occasionally transmit on uplink channels when no uplink grant is given. This happens e.g. in case of random access preambles, hybrid automatic repeat request (HARQ) retransmissions and acknowledgements, scheduling requests and channel quality indication (CQI) reports. Without the described reverse scheduling, the base station 400, 204/206 has limited or no means to prevent this from happening.

On the other hand, the base station 400, 204/206 may not switch off downlink signal without notifying the terminals since synchronization, channel estimation and tracking algorithms running on the terminals may expect that synchronization and reference signals transmitted by the base station are present at all times.

The base station 400, 204/206 may schedule resources to the terminals with fair or less fair scheduling algorithms, but there is no technology in use, except the described reverse scheduling, which would ease and allow rapid control of the interference for the terminals in bad radio conditions. In general, interference is minimized with network planning but once the network is deployed interference control mechanisms are limited. In LTE and successor technologies resources to the terminals may be scheduled for each one millisecond subframe separately or semi-persistent scheduling (SPS) may be used for longer semi-static allocations.

The base station 400, 204/206 may utilize existing scheduling mechanisms to create either uplink or downlink reverse allocations to the terminals. Such changes are easily pinpointed to the existing products, i.e. the embodiments are readily implemented by the skilled person. This allocation explicitly notifies those one millisecond subframe periods when not to transmit anything on uplink channels or when no downlink signal is present. With this mechanism, network mutes selected terminals or signals to the terminals that the downlink is muted on the cell in certain subframe or pattern of subframes. Also certain already allocated semi-persistent allocations may be cancelled without removing the whole semi-persistent allocation. This may provide a way to quickly and precisely eliminate intercell and/or terminal-to-terminal interference temporarily on selected areas.

Technical implementation for LTE and successor technologies is considered here. For delivering reverse allocations or semi-persistent allocations to terminals, current scheduling mechanisms may be used. Some parameter in downlink control information (DCI) format may be used for indicating that reverse allocation is indicated instead of normal allocation.

For example, resource indication values (RIV) that are normally used for indicating allocated frequency resources contain certain amount of invalid unused values when resource allocation type 2 is used. Utilizing some of these invalid values reverse allocation may be notified to the terminal by using downlink control information (DCI) format 1A for downlink and DCI format 0 for uplink. These DCI formats may be used in every transmission mode and with every RNTI (Radio Network Temporary Identifier) type which provides universal and flexible solution. Further bits in the DCI block may be used for signaling the subframe pattern and possibly other relevant parameters.

At least some of the example embodiments may give more flexibility for network to schedule terminals and control interference. Certain terminals or cells may be muted for certain short time periods dynamically and with very short delay. This muting may be utilized e.g. for improving cell edge user conditions at least for short periods if interfering cells or/and terminals may be muted. Also, in future LTE-Advanced scenarios where there might be smaller hotspot cells inside bigger cells in heterogeneous networks, reverse allocations may be utilized for creating temporary and efficient muting patterns for certain areas dynamically. In cellular networks with high mobility and changing number of terminals, network may easily and rapidly respond to current situation and take also terminals with worse radio conditions more fairly into account.

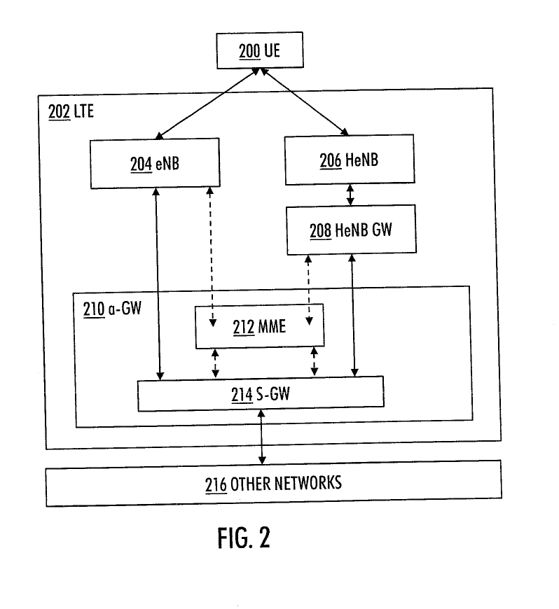

With reference to FIG. 3, let us study the structure of the terminal 300 in more detail. The terminal 300 may be implemented like an electronic digital computer, which may comprise, besides the processor 102 and the memory 104, a number of other parts. In addition to the working memory 104, a non-volatile memory 302 may be needed. Additionally, the terminal 300 may comprise a system clock 328. Furthermore, the terminal 300 may comprise a number of peripheral devices. In FIG. 3, three peripheral devices are illustrated: a battery 332, a transceiver 324, and a user interface 330. Naturally, the terminal 300 may comprise a number of other peripheral devices, not illustrated here for the sake of clarity.

The user interface 330 may comprise user interface circuitry (such as integrated circuits and devices such as touch-screen, keypad etc.) and user interface computer program code configured to facilitate user control of at least some functions of the terminal 300. The battery 332 may be an electrical battery including electrochemical cells that convert stored chemical energy into electrical energy.

The system clock 328 constantly generates a stream of electrical pulses, which cause the various transferring operations within the terminal 300 to take place in an orderly manner and with specific timing.

The transceiver 324 may implement a telecommunications connection between the terminal 300 and some other device. A wireless connection may be implemented with a wireless transceiver operating according to the earlier mentioned standards, such as the LTE, WLAN or any other suitable standard/non-standard wireless communication means. The transceiver 324 may comprise standard well-known components such as an amplifier, filter, frequency-converter, (de)modulator, encoder/decoder circuitries, and one or more antennas.

Additionally, the terminal 300 may communicate with other devices through its memory, e.g. the data 304 may have been brought into the non-volatile memory 302 via a memory device (such as a memory card, an optical disk, or any other suitable non-volatile memory device).

The term ‘processor’ 102 refers to a device that is capable of processing data. Depending on the processing power needed, the terminal 100 may comprise several (parallel) processors 102. The processor 102 may comprise an electronic circuitry. When designing the implementation, a person skilled in the art will consider the requirements set for the size and power consumption of the terminal 300, the necessary processing capacity, production costs, and production volumes, for example. The electronic circuitry of the processor 102 and the memory 104 may comprise one or more logic components, one or more standard integrated circuits, one or more application-specific integrated circuits (ASIC), one or more microprocessors, one or more processors with accompanying digital signal processors, one or more processors without accompanying digital signal processors, one or more special-purpose computer chips, one or more field-programmable gate arrays (FPGA), one or more controllers, hardware-only circuit implementations, such as implementations in only analogue and/or digital circuitry, combinations of circuits and software (and/or firmware), such as (as applicable): a combination of processor(s) or portions of processor(s)/software including digital signal processor(s), software, and memory(ies) that work together to cause an apparatus to perform various functions, circuits, such as a microprocessor(s) or a portion of a microprocessor(s), that require software or firmware for operation, even if the software or firmware is not physically present, and/or other suitable electronic structures. This definition of ‘circuitry’ applies to all uses of this term in this application. As a further example, as used in this application, the term “circuitry” would also cover an implementation of merely a processor (or multiple processors) 102 or portion of a processor 102 and its (or their) accompanying software and/or firmware. The term “circuitry” would also cover, for example and if applicable to the particular element, a baseband integrated circuit or applications processor integrated circuit for a user equipment.

The microprocessor 102 may implement functions of a central processing unit (CPU) on an integrated circuit. The CPU is a logic machine executing a computer program 334, which comprises computer program code 106. The program code 106 may be coded as a computer program using a programming language, which may be a high-level programming language, such as C, or Java, or a low-level programming language, such as a machine language, or an assembler. The program code 106 may also be hard-wired, e.g. if the processor 102 is implemented as an ASIC, the program code is implemented as blocks developed and implemented by appropriate ASIC development tools.

The CPU may comprise a set of registers 318, an arithmetic logic unit (ALU) 320, and a control unit (CU) 322. The control unit 322 is controlled by a sequence of program code 106 transferred to the CPU from the working memory 104. The control unit 322 may contain a number of microinstructions for basic operations. The implementation of the microinstructions may vary, depending on the CPU design. The processor 102 may also have an operating system (a general purpose operating system, a dedicated operating system of an embedded system, or a real-time operating system, for example), which may provide the computer program 334 with system services. Examples of operating systems include: MeeGo, Symbian, Android, iOS, RIM Blackberry OS, Windows Mobile, Linux, bada, Maemo etc.

There may be three different types of buses between the working memory 104 and the processor 102: a data bus 310, a control bus 312, and an address bus 314. The control unit 322 uses the control bus 312 to set the working memory 104 in two states, one for writing data into the working memory 104, and the other for reading data from the working memory 104. The control unit 322 uses the address bus 314 to send to the working memory 104 address signals for addressing specified portions of the memory 104 in writing and reading states. The data bus 310 is used to transfer data 308 from the working memory 104 to the processor 102 and from the processor 102 to the working memory 104, and to transfer the program code 106 from the working memory 104 to the processor 102.

The working memory 104 may be implemented as a random-access memory (RAM), where the information is lost after the power is switched off. The RAM is capable of returning any piece of data in a constant time, regardless of its physical location and whether or not it is related to the previous piece of data.

The non-volatile memory 302 retains the stored information even when not powered. Examples of non-volatile memory include read-only memory (ROM), flash memory, magnetic computer storage devices such as hard disk drives, and optical discs. As is shown in FIG. 3, the non-volatile memory 302 may store both data 304 and a computer program 334 comprising program code 106.

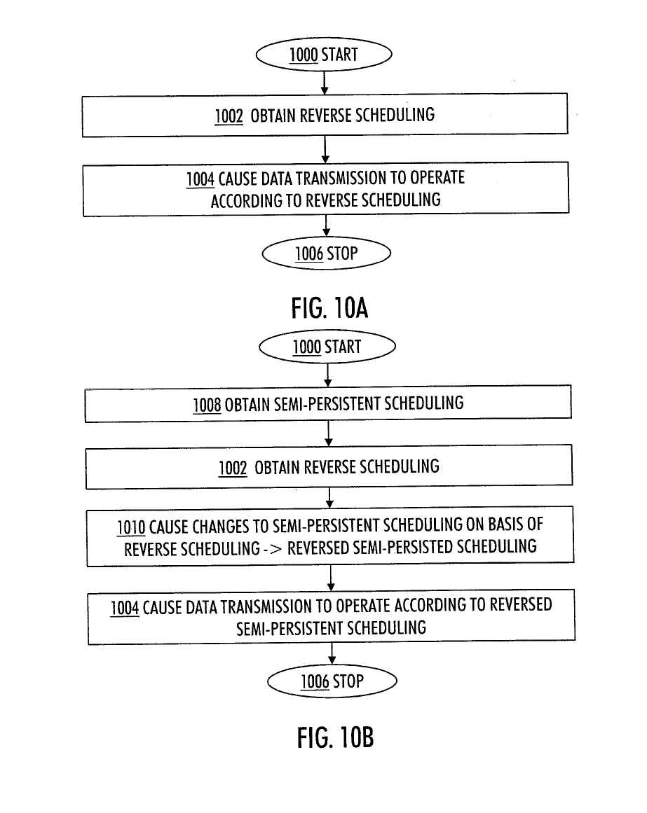

An example embodiment provides a computer-readable medium 332 comprising computer program code which, when loaded into the terminal 300, cause the apparatus to perform the required operations, illustrated as a method with reference to FIGS. 10A and 10B later on. The computer-readable medium 332 may be a non-transitory computer readable storage medium storing the computer program 334 comprising program code 106. The computer program 334 may be in source code form, object code form, executable form or in some intermediate form. The computer-readable medium 332 may be any entity or device capable of carrying the program 334 to the terminal 300. The medium 332 may be implemented as follows, for example: the computer program 334 may be embodied on a record medium, stored in a computer memory, embodied in a read-only memory, carried on an electrical carrier signal, carried on a telecommunications signal, and/or embodied on a software distribution medium. In some jurisdictions, depending on the legislation and the patent practice, the medium 332 may not be the telecommunications signal. The medium 332 may be a non-transitory computer-readable storage medium.

FIG. 3 illustrates that the medium 332 may be coupled with the terminal 300, whereupon the program 334 comprising the program code 106 is transferred into the non-volatile memory 302 of the terminal 300. The program 334 with its program code 106 may be loaded from the non-volatile memory 302 into the working memory 104. During running of the program 334, the program instructions 106 are transferred via the data bus 310 from the working memory 104 into the control unit 322, wherein usually a portion of the program code 106 resides and controls the operation of the terminal 300.

There are many ways to structure the program 334. The operations of the program may be divided into functional modules, sub-routines, methods, classes, objects, applets, macros, widgets, design blocks etc., depending on the software design methodology and the programming language used. In modern programming environments, there are software libraries, e.g. compilations of readymade functions, which may be utilized by the program for performing a wide variety of standard operations.

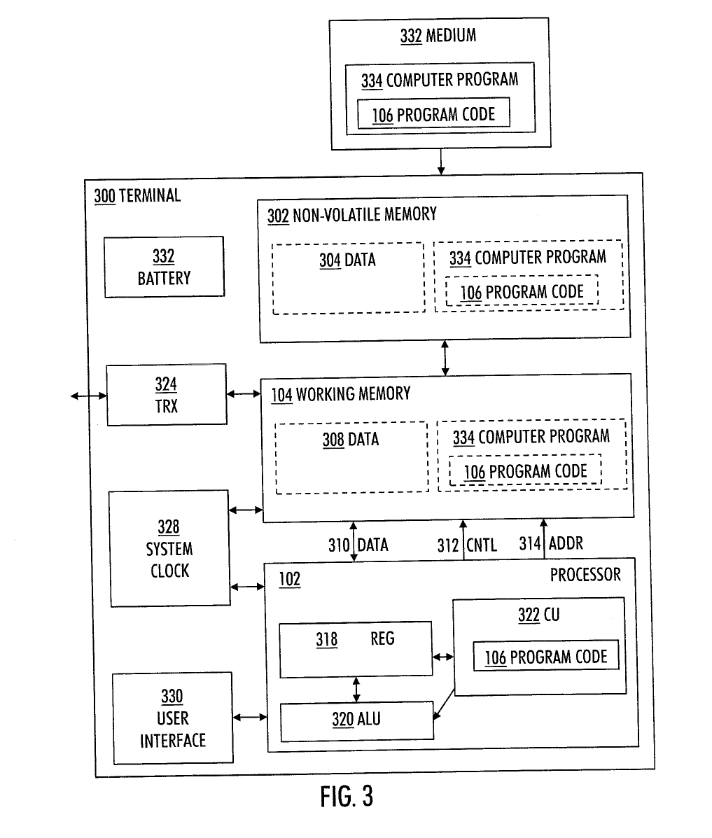

With reference to FIG. 4, let us study the structure of the base station 400 in more detail. The base station 400 may be implemented like an electronic digital computer, which may comprise, besides the processor 132 and the memory 134, a number of other parts. Basically, the description of FIG. 4 resembles the description of FIG. 3, and, consequently, the following explanation will only note the differences. In FIG. 4, two peripheral devices are illustrated: a power source 406, and a transceiver TRX 408. Naturally, the base station 400 may comprise a number of other peripheral devices, not illustrated here for the sake of clarity.

The transceiver 408 may implement a telecommunications connection between the base station 400 and the terminal 300. A wireless connection may be implemented with a wireless transceiver operating according to the earlier mentioned standards, such as the LTE, or any other suitable standard/non-standard wireless communication means.

The power source 406 may be an independent power source, such as an electrical battery, a solar cell, or other means of generating energy, or it may be dependent from the outside world (of the base station 400), such as a power supply connected to a wall outlet (mains).

Data stored in the non-volatile memory 302 is now denoted with reference numeral 404, and data stored in the working memory 134 by reference numeral 406.

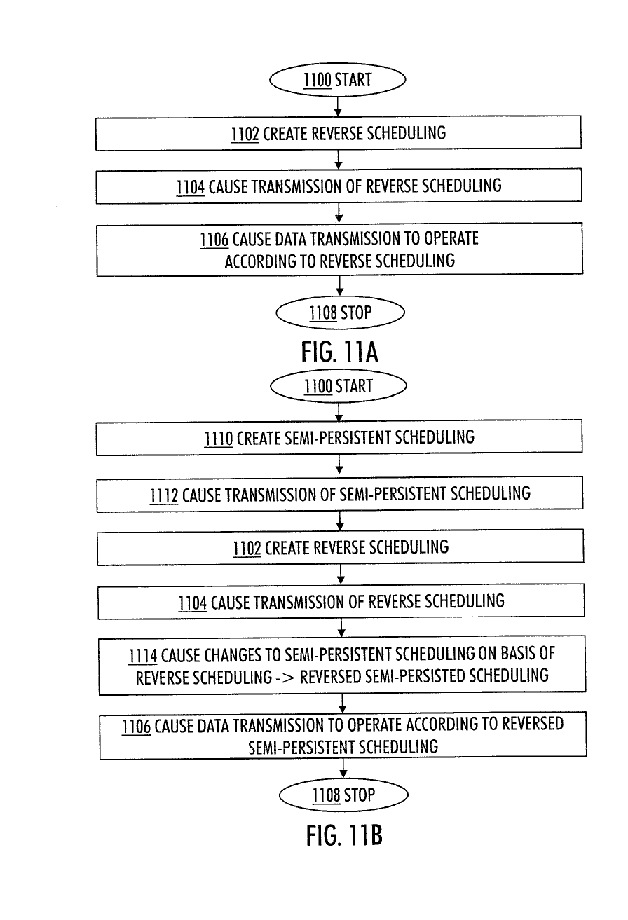

An example embodiment provides a computer-readable medium 332 comprising computer program code which, when loaded into the base station 400, cause the apparatus to perform the required operations, illustrated as a method with reference to FIGS. 11A and 11B later on.

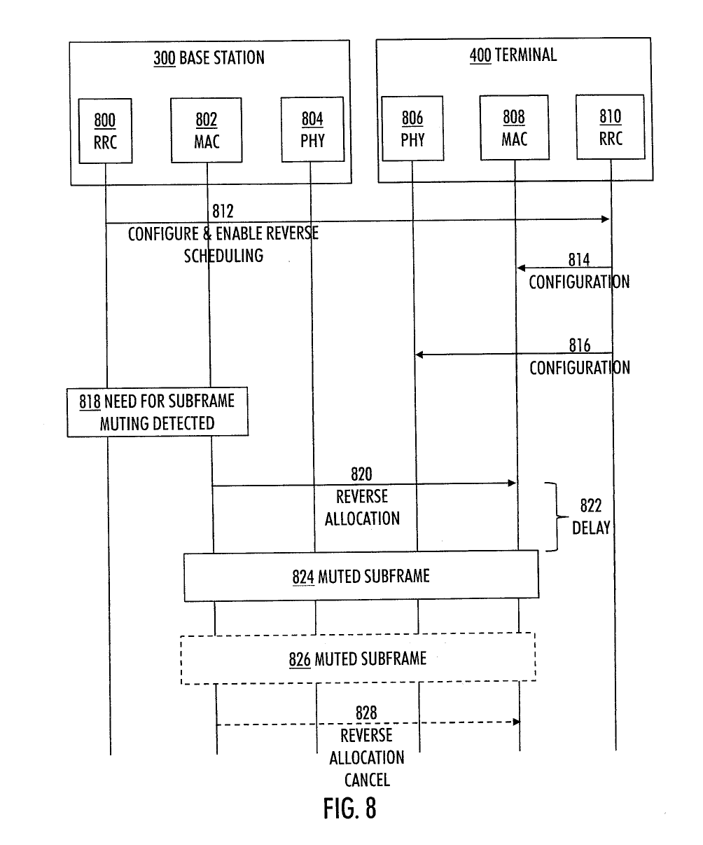

FIG. 8 illustrates an example embodiment of a signal sequence between the base station 300 and the terminal 400. It is illustrated how configuration and allocations flow between layers. The signaling messages are only exemplary and may even comprise several separate messages for transmitting the same information. In addition, the messages may also contain other information. The base station has at least the following protocol stack: a radio resource control (RRC) layer 800, a medium access control (MAC) layer 802, and a physical (PHY) layer 804. Correspondingly, the terminal 400 has at least the following protocol stack: a PHY layer 804, a MAC layer 808, and a RRC layer 810.

The reverse scheduling may be a feature that is always on. Alternatively, the reverse scheduling may need configuration and/or enablement: in FIG. 8 this is achieved by communication 812 between the RRC layers 800, 810, and, by internal configuration with the message 814 from the RRC layer 810 to the MAC layer 808, and with the message 816 from the RRC layer 810 to the PHY layer 806.

The need for subframe muting may be detected 818 in RRC layer 800 and/or MAC layer 802 of the base station 300. The need for subframe muting may be detected by all feasible ways, by mechanisms related to interference co-ordination, for example.

The MAC layer 802 of the base station 300 transmits 820 the reverse allocation to the MAC layer 808 of the terminal 300. After a delay 822, the subframe may be muted 824, which affects the functioning of the PHY layers 804, 806 and MAC layers 802, 808. Note that one millisecond may be a minimum reaction time in some cases (such as in the LTE). It may also be defined longer for uplink if the terminal 400 needs more time to cancel its uplink transmission. In normal uplink allocations, if allocation is received in subframe N, then uplink transmission shall happen in subframe N+4. Consequently, this N+4 rule may also be reasonable for uplink reverse allocations. Additionally, there is some timing advance in uplink transmissions, which makes one millisecond reaction time challenging for uplink. In downlink direction, one millisecond works fine. Reverse allocation may be defined to one or several subframes long and non-persistent or semi-persistent. In FIG. 8, two muted subframes 824, 826 are shown. It is also shown that a special reverse allocation cancel message may be transmitted 828 from the MAC layer 802 of the base station 300 to the MAC layer 808 of the terminal 400, whereupon the reversed semi-permanent scheduling is ended, i.e. semi-permanent scheduling comes back into force.

In order to utilize the shared channel resources efficiently, a scheduling function may be used in the MAC layer, for which the scheduler operation, signaling of scheduler decisions and measurements to support scheduler operation are determined. The scheduler may take into account of the traffic volume and the quality of service (QoS) requirements of each terminal and associated radio bearers. Resource assignment may comprise physical resource blocks (PRB), modulation and coding schemes (MCS), and additional information (allocation time, allocation repetition factor). Carrier aggregation may also be applied, in which transmissions between the terminal and the base station are aggregated on multiple carriers (on same frequency band, on different frequency bands, and/or with different radio access technologies). Note that as the reverse scheduling signaling is implemented at physical layer and/or MAC layer, the reverse scheduling may react fast to the ever-changing radio environment and its circumstances. The reverse scheduling may thus be implemented in a dynamic and explicit fashion, meaning that the processing time is kept short and the processing requirements relatively low.

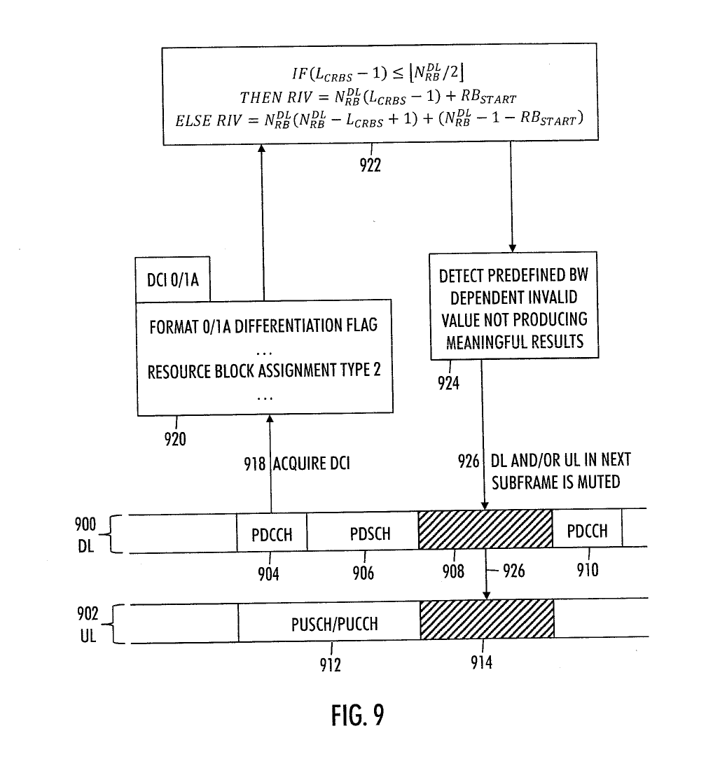

FIG. 9 illustrates one example embodiment of how reverse allocation may be detected in the terminal. DCI formats 920 are decoded 918 from a physical downlink control channel (PDCCH) 904 of the downlink 900. Then RIV is calculated 922, and a predefined invalid value is detected 924, which leads 926 to at least one muted downlink 900 subframe 908 of the physical downlink shared channel (PDSCH) 906, and/or at least one muted uplink 902 subframe 914 of the physical uplink shared channel (PUSCH)/physical uplink control channel (PUCCH) 912. In the next PDCCH frame(s) 910, a new reverse scheduling command may be given, if needed. In this way, as the downlink assignment and uplink grant messages may be reused also for the reverse scheduling, the embodiments may be implemented to the existing environments with minimal changes. Additionally, such reverse scheduling signaling is fast enabling fast reaction times.

Next, example embodiments of a method will be described with reference to FIGS. 10A and 10B. The method may be performed in the apparatus 100. The method may be implemented as the apparatus 100 or the computer program 334 comprising program code 106 which, when loaded into the apparatus 100, cause the apparatus 100 to perform the process to be described. The example embodiments of the apparatus 100 may also be used to enhance the method, and, correspondingly, the example embodiments of the method may be used to enhance the apparatus 100. The operations are not strictly in chronological order, and some of the operations may be performed simultaneously or in an order differing from the given ones. Other functions may also be executed between the operations or within the operations and other data exchanged between the operations. Some of the operations or part of the operations may also be left out or replaced by a corresponding operation or part of the operation. It should be noted that no special order of operations is required in the method, except where necessary due to the logical requirements for the processing order.

In the embodiment of FIG. 10A, the method starts in 1000. In 1002, a reverse scheduling received by a terminal from a base station is obtained. The reverse scheduling comprises information indicating that at least a part of subframes is not utilized for a radio data transmission between the terminal and the base station. In 1004, the radio data transmission between the terminal and the base station is caused to operate according to the reverse scheduling. The method ends in 1006.The embodiment of FIG. 10B also starts in 1000. In 1008, a semi-persistent scheduling received by a terminal from a base station is obtained. The semi-persistent scheduling comprises information on scheduling of subframes utilized in the radio data transmission between the terminal and the base station.

In 1002, a reverse scheduling received by the terminal from the base station is obtained.

The reverse scheduling may further comprise information indicating that the at least part of the subframes is not used in at least one of the following subframes utilized in the radio data transmission between the terminal and the base station. Additionally, or alternatively, the reverse scheduling may further comprise information indicating that the at least part of the subframes is not used until further notice in the radio data transmission between the terminal and the base station.

The reverse scheduling may further comprise information indicating that at least a part of downlink shared channels and/or a part of downlink control channels is not utilized for the radio data transmission from the base station to the terminal. Additionally, or alternatively, the reverse scheduling may further comprise information indicating that at least a part of uplink shared channels and/or a part of uplink control channels is not utilized for the radio data transmission from the terminal to the base station.

In 1010, changes to the semi-persistent scheduling are caused on the basis of the reverse scheduling, thereby arriving at a reversed semi-persistent scheduling.

In 1004, a radio data transmission between the terminal and the base station is caused to operate according to the reversed semi-persistent scheduling.

The method ends in 1006.

Next, example embodiments of a method will be described with reference to FIGS. 11A and 11B. The method may be performed in the apparatus 130. The method may be implemented as the apparatus 130 or the computer program 402 comprising program code 136 which, when loaded into the apparatus 130, cause the apparatus 130 to perform the process to be described. The example embodiments of the apparatus 130 may also be used to enhance the method, and, correspondingly, the example embodiments of the method may be used to enhance the apparatus 130. The operations are not in strict chronological order, and some of the operations may be performed simultaneously or in an order differing from the given one. Other functions may also be executed between the operations or within the operations and other data exchanged between the operations. Some of the operations or part of the operations may also be left out or replaced by a corresponding operation or part of the operation. It should be noted that no special order of operations is required in the method, except where necessary due to the logical requirements for the processing order.

In the embodiment of FIG. 11A, the method starts in 1100. In 1102, a reverse scheduling is created for a terminal. The reverse scheduling comprises information indicating that at least a part of subframes is not utilized for a radio data transmission between the terminal and a base station. In 1104, a transmission of the reverse scheduling is caused from the base station to the terminal. In 1106, the radio data transmission between the terminal and the base station radio is caused to operate according to the reverse scheduling. The method ends in 1108.The embodiment of FIG. 11B also starts in 1100. In 1110, a semi-persistent scheduling for a terminal communicating with a base station is created. The semi-persistent scheduling comprises information on scheduling of subframes utilized in radio data transmission between the terminal and the base station.

In 1112, a transmission of the semi-persistent scheduling is caused from the base station to the terminal.

In 1102, a reverse scheduling is created for the terminal.

The reverse scheduling may further comprise information indicating that the at least part of the subframes is not used in at least one of the following subframes utilized in the radio data transmission between the terminal and the base station. Additionally, or alternatively, the reverse scheduling may further comprise information indicating that the at least part of the subframes is not used until further notice in the radio data transmission between the terminal and the base station.

The reverse scheduling may further comprise information indicating that at least a part of downlink shared channels and/or downlink control channels is not utilized for the radio data transmission from the base station to the terminal. Additionally, or alternatively, the reverse scheduling may further comprise information indicating that at least a part of uplink shared channels and/or uplink control channels is not utilized for the radio data transmission from the terminal to the base station.

In 1104, a transmission of the reverse scheduling is caused from the base station to the terminal.

In 1114, changes to the semi-persistent scheduling are caused on the basis of the reverse scheduling, thereby arriving at a reversed semi-persistent scheduling.

In 1106, a radio data transmission between the terminal and the base station radio is caused to operate according to the reversed semi-persistent scheduling.

The method ends in 1108.

The present invention is applicable to radio systems defined above but also to other suitable telecommunication systems. The protocols used, the specifications of radio systems, their base stations, and terminals develop rapidly. Such development may require extra changes to the described example embodiments. Therefore, all words and expressions should be interpreted broadly and they are intended to illustrate, not to restrict, the example embodiments. It will be obvious to a person skilled in the art that, as technology advances, the inventive concept can be implemented in various ways. The invention and its example embodiments are not limited to the examples described above but may vary within the scope of the claims.

1. An apparatus comprising:
at least one processor; and
at least one memory including computer program code;
the at least one memory and the computer program code are configured to, with the at least one processor, cause the apparatus to perform at least the following:
obtain a reverse scheduling received by a terminal from a base station, the reverse scheduling comprising information indicating that at least a part of subframes is not utilized for a radio data transmission between the terminal and the base station; and
cause a radio transceiver of the terminal to operate according to the reverse scheduling in the radio data transmission between the terminal and the base station.

2. The apparatus of claim 1, wherein the at least one memory and the computer program code are further configured to, with the at least one processor, cause the apparatus to perform at least the following:
obtain a semi-persistent scheduling received by the terminal from the base station, the semi-persistent scheduling comprising information on scheduling of the subframes utilized in the radio data transmission between the terminal and the base station;
cause changes to the semi-persistent scheduling on the basis of the reverse scheduling, thereby arriving at a reversed semi-persistent scheduling; and
cause the radio transceiver of the terminal to operate according to the reversed semi-persistent scheduling in the radio data transmission between the terminal and the base station.

3. The apparatus of claim 1, wherein the reverse scheduling further comprises at least one of the following information:
information indicating that the at least part of the subframes is not used in at least one of the following subframes utilized in the radio data transmission between the terminal and the base station; or
information indicating that the at least part of the subframes is not used until further notice in the radio data transmission between the terminal and the base station.

4. The apparatus of claim 1, wherein the reverse scheduling further comprises at least one of the following information:
information indicating that at least a part of downlink shared channels is not utilized for the radio data transmission from the base station to the terminal; or
information indicating that at least a part of uplink shared channels is not utilized for the radio data transmission from the terminal to the base station; or
information indicating that at least a part of downlink control channels is not utilized for the radio data transmission from the base station to the terminal; or
information indicating that at least a part of uplink control channels is not utilized for the radio data transmission from the terminal to the base station.

5. The apparatus of claim 1, wherein the apparatus is a terminal of a cellular communication system, and the apparatus further comprises:
user interface circuitry and user interface computer program code configured to facilitate user control of at least some functions of the terminal.

6. An apparatus comprising:
at least one processor; and
at least one memory including computer program code;
the at least one memory and the computer program code are configured to, with the at least one processor, cause the apparatus to perform at least the following:
create a reverse scheduling for a terminal, the reverse scheduling comprising information indicating that at least a part of subframes is not utilized for a radio data transmission between the terminal and a base station;
cause a transmission of the reverse scheduling from the base station to the terminal; and
cause a radio transceiver of the base station to operate according to the reverse scheduling in the radio data transmission between the terminal and the base station.

7. The apparatus of claim 6, wherein the at least one memory and the computer program code are further configured to, with the at least one processor, cause the apparatus to perform at least the following:
create a semi-persistent scheduling for the terminal communicating with the base station, the semi-persistent scheduling comprising information on scheduling of the subframes utilized in the radio data transmission between the terminal and the base station;
cause a transmission of the semi-persistent scheduling from the base station to the terminal;
cause changes to the semi-persistent scheduling on the basis of the reverse scheduling, thereby arriving at a reversed semi-persistent scheduling; and
cause the radio transceiver of the base station to operate according to the reversed semi-persistent scheduling in the radio data transmission between the terminal and the base station.

8. The apparatus of claim 6, wherein the reverse scheduling further comprises at least one of the following information:
information indicating that the at least part of the subframes is not used in at least one of the following subframes utilized in the radio data transmission between the terminal and the base station; or
information indicating that the at least part of the subframes is not used until further notice in the radio data transmission between the terminal and the base station.

9. The apparatus of claim 6, wherein the reverse scheduling further comprises at least one of the following information:
information indicating that at least a part of downlink shared channels is not utilized for the radio data transmission from the base station to the terminal; or
information indicating that at least a part of uplink shared channels is not utilized for the radio data transmission from the terminal to the base station; or
information indicating that at least a part of downlink control channels is not utilized for the radio data transmission from the base station to the terminal; or
information indicating that at least a part of uplink control channels is not utilized for the radio data transmission from the terminal to the base station.

10. The apparatus of claim 6, wherein the apparatus is a base station of a cellular communication system, and the apparatus further comprises:
a radio transceiver configured to communicate with the terminal.

11. A method comprising:
obtaining a reverse scheduling received by a terminal from a base station, the reverse scheduling comprising information indicating that at least a part of subframes is not utilized for a radio data transmission between the terminal and the base station; and
causing the radio data transmission between the terminal and the base station to operate according to the reverse scheduling.

12. The method of claim 11, further comprising:
obtaining a semi-persistent scheduling received by the terminal from the base station, the semi-persistent scheduling comprising information on scheduling of subframes utilized in the radio data transmission between the terminal and the base station;
causing changes to the semi-persistent scheduling on the basis of the reverse scheduling, thereby arriving at a reversed semi-persistent scheduling; and
causing the radio data transmission between the terminal and the base station to operate according to the reversed semi-persistent scheduling.

13. The method of claim 11, wherein the reverse scheduling further comprises at least one of the following information:
information indicating that the at least part of the subframes is not used in at least one of the following subframes utilized in the radio data transmission between the terminal and the base station; or
information indicating that the at least part of the subframes is not used until further notice in the radio data transmission between the terminal and the base station.

14. The method of claim 11, wherein the reverse scheduling further comprises at least one of the following information:
information indicating that at least a part of downlink shared channels is not utilized for the radio data transmission from the base station to the terminal; or
information indicating that at least a part of uplink shared channels is not utilized for the radio data transmission from the terminal to the base station;
information indicating that at least a part of downlink control channels is not utilized for the radio data transmission from the base station to the terminal; or
information indicating that at least a part of uplink control channels is not utilized for the radio data transmission from the terminal to the base station.

15. (canceled)

16. A method comprising:
creating a reverse scheduling for a terminal, the reverse scheduling comprising information indicating that at least a part of subframes is not utilized for a radio data transmission between the terminal and a base station;
causing a transmission of the reverse scheduling from the base station to the terminal; and
causing the radio data transmission between the terminal and the base station radio to operate according to the reverse scheduling.

17. The method of claim 16, further comprising:
creating a semi-persistent scheduling for the terminal communicating with the base station, the semi-persistent scheduling comprising information on scheduling of the subframes utilized in the radio data transmission between the terminal and the base station;
causing a transmission of the semi-persistent scheduling from the base station to the terminal;
causing changes to the semi-persistent scheduling on the basis of the reverse scheduling, thereby arriving at a reversed semi-persistent scheduling; and
causing the radio data transmission between the terminal and the base station radio to operate according to the reversed semi-persistent scheduling.

18. The method of claim 16, wherein the reverse scheduling further comprises at least one of the following information:
information indicating that the at least part of the subframes is not used in at least one of the following subframes utilized in the radio data transmission between the terminal and the base station; or
information indicating that the at least part of the subframes is not used until further notice in the radio data transmission between the terminal and the base station.

19. The method of claim 16, wherein the reverse scheduling further comprises at least one of the following information:
information indicating that at least a part of downlink shared channels is not utilized for the radio data transmission from the base station to the terminal; or
information indicating that at least a part of uplink shared channels is not utilized for the radio data transmission from the terminal to the base station; or
information indicating that at least a part of downlink control channels is not utilized for the radio data transmission from the base station to the terminal; or
information indicating that at least a part of uplink control channels is not utilized for the radio data transmission from the terminal to the base station.
